(19) United States
(12) Patent Application Publication
(10) Pub. No.: US 2021/0144515 A1
(43) Pub. Date: May 13, 2021

(54) SYSTEMS AND METHODS FOR MULTI-ACCESS EDGE COMPUTING NODE SELECTION

(71) Applicant: Verizon Patent and Licensing Inc., Arlington, VA (US)

(72) Inventors: Patricia R. CHANG, San Ramon, CA (US); Daryl M. LOW, San Jose, CA (US); Lalit R. KOTECHA, San Ramon, CA (US)

(21) Appl. No.: 16/681,464

(22) Filed: Nov. 12, 2019

(51) Int. Cl. H04W 4/029; H04W 84/18; G06F 9/54

(52) U.S. Cl. CPC H04W 4/029; G06F 9/541; H04W 84/18

(57) ABSTRACT

A multi-access edge computing (MEC) node selection platform may receive, from a user device, a request to access a service via MEC. The MEC node selection platform may determine a geographical location of the user device. The MEC node selection platform may obtain a MEC node performance report, wherein the MEC node performance report indicates one or more performance indicators for one or more candidate MEC nodes configured to provide access to the service. The MEC node selection platform may select, based on the one or more performance indicators and the geographical location of the user device, a MEC node from one or more candidate MEC nodes. The MEC node selection platform may provide, to the user device, information to be used by the user device to communicate with the MEC node.

### BACKGROUND

Multi-access edge computing (MEC) is a network architecture of MEC nodes (e.g., devices, virtual machines, and/or the like) that may operate at an edge of a cellular network. The MEC nodes may perform operations of the cellular network for connected user devices that are within a coverage area of the MEC resources.

### BRIEF DESCRIPTION OF THE DRAWINGS

FIGS. 1A-1C are diagrams of one or more example implementations described herein.

FIG. 2 is a diagram of an example environment in which systems and/or methods described herein may be implemented.

FIG. 3 is a diagram of example components of one or more devices of FIG. 2.

FIG. 4 is a flow chart of an example process for selecting a MEC node to provide a service to a user device.

### DETAILED DESCRIPTION OF PREFERRED EMBODIMENTS

The following detailed description of example implementations refers to the accompanying drawings. The same reference numbers in different drawings may identify the same or similar elements.

In some instances, a user device may request access, via a network node, to a service provided via multi-access edge computing (MEC). The network node may be associated with a wireless network that provides access to MEC. The network node may facilitate a connection between the user device and a MEC node based on a geographical location of the user device and/or the MEC node. For example, the network node may receive the request including a domain name and convert the domain name into a network address (e.g., an internet protocol (IP) address) of the MEC node that is geographically closest to the user device. However, facilitating the connection between the user device and the MEC node based solely, or substantially solely, on geography may result in a connection that does not satisfy performance requirements for the service and/or may cause overloading of the MEC node that is geographically closest to the user device.

According to some implementations described herein, a MEC node selection platform may receive a request from a user device to access a service via MEC. The MEC node selection platform may obtain a MEC node performance report from a MEC node orchestrator. The performance report may identify one or more candidate MEC nodes that are configured to provide access to the service. The performance report may further provide one or more performance indicators related to load, network capabilities and/or resources, computing capabilities and/or resources, and/or the like for the one or more candidate MEC nodes. The MEC node selection platform may determine a geographical location of the user device (e.g., from the request, based on an established communication channel with the user device, from a network node associated with the network providing a connection between the MEC node selection platform and the user device, and/or the like) and/or geographical locations of the one or more candidate MEC nodes (e.g., based on the performance report, information received from another network device, and/or the like). Based on the performance report and/or the geographical location of the user device, the MEC node selection platform may select a MEC node from the one or more candidate MEC nodes. The MEC node selection platform may provide, to the user device, information to be used by the user device to communicate with the MEC node (e.g., a network address of the MEC node).

By selecting the MEC node based on the performance report, including the performance indicators, the MEC node selection platform may facilitate a connection between the user device and the MEC node that may have a relatively high likelihood of satisfying the performance requirements of the service. This may reduce an amount of computing resources and/or network resources that may otherwise have been used to detect and/or recover from errors in communications, via the connection, related to the service. Additionally, selecting the MEC node based on the performance report may reduce an amount of computing resources and/or network resources that may otherwise be used to recover from overloading a geographically closest MEC node.

FIGS. 1A-1C are diagrams of one or more example implementations 100 described herein. As shown in FIGS. 1A-1C, the example implementation(s) 100 may include a MEC node selection platform 102, a user device 104, a MEC node orchestrator 106, one or more candidate MEC nodes 108-1 through 108-N, a selected MEC node 110, and/or the like.

As shown in FIG. 1A, and by reference number 112, the MEC node selection platform 102 may receive, from the user device 104, a request for a service via MEC. In some implementations, the MEC node selection platform 102 may receive the request from the user device 104 over a wired or wireless network through which the MEC node selection platform 102 and the user device 104 may already be connected.

In some implementations, the request may identify a domain name associated with the service. The request may further indicate that the request is to access the service via MEC. In some implementations, the MEC node selection platform 102 may receive the request via a browser request (e.g., as a host name, a domain name, and/or the like). For example, the browser request may identify the domain name as MEC.serviceprovider.com to indicate that the request is to access a service via MEC associated with the service provider. In another example, the browser request may identify the domain name as MECVR.serviceprovider.com to indicate that the request is to access a virtual reality service via MEC associated with the service provider.

In some implementations, the MEC node selection platform 102 is configured to perform a domain name system (DNS) service lookup (to convert domain names into network addresses). The MEC node selection platform 102 may convert the domain names into network addresses based on entries in a data structure. For example, the MEC node selection platform 102 may use a lookup table to identify one or more candidate network addresses that are associated with a particular domain name. In some implementations, the MEC node selection platform 102 may identify more than one candidate network address that is associated with the particular domain name and may need to determine which one of the candidate network addresses should be matched with the particular domain name for request from the user device 104.

In some implementations, the MEC node selection platform 102 may receive the request via an application programming interface (API). The API may be associated with an application (e.g., a MEC service requesting application, an application that is used to exchange information via MEC, and/or the like) that is local to the user device 104. In some implementations, the MEC node selection platform 102 may receive the request via an interactive website.

The request may include one or more fields of information including indications of characteristics of the service such as an identification of the service, a performance requirement for the service, a service type of the service, the geographical location of the user device 104, a subscription status of a user of the user device 104, and/or the like. In some implementations, the request includes indications of one or more characteristics of the service, which may be used by the MEC node selection platform 102 to identify additional characteristics of the service. For example, the MEC node selection platform 102 may receive a request identifying a particular service. The MEC node selection platform 102 may identify a service type and/or a performance requirement associated with the service based on the identification of the particular service.

As shown by reference number 114, the MEC node selection platform 102 may determine a geographical location of the user device 104. The MEC node selection platform 102 may determine the geographical location of the user device 104 based on information within the request, information in other communications between the MEC node selection platform 102 and the user device 104, communications between the user device 104 and a network node of the wireless network, and/or the like.

In some implementations, the MEC node selection platform 102 may use the geographical location of the user device 104 to identify a set of candidate MEC nodes that may be available to provide access to the service. For example, the MEC node selection platform 102 may identify the set of candidate MEC nodes based on MEC nodes being within a threshold distance from the geographical location of the user device 104. In other examples, the MEC node selection platform 102 may identify the set of candidate MEC nodes based on a threshold quantity of geographically closest MEC nodes to the user device 104.

As shown by reference number 116, the MEC node selection platform 102 may request a MEC node performance report from the MEC node orchestrator 106. The request may indicate the geographical location of the user device 104, identities of the set of candidate MEC nodes, an identity of the service, a performance requirement for the service, a service type of the service, a subscription status of the user of the user device 104, and/or the like.

As shown in FIG. 1B, and by reference number 118, the MEC node orchestrator 106 may generate a MEC node performance report for the one or more candidate MEC nodes 108-1 through 108-N. In some implementations, the MEC node orchestrator 106 may use information from the request to identify the one or more candidate MEC nodes 108-1 through 108-N for which information will be provided in the MEC node performance report. For example, the MEC node orchestrator 106 may identify the one or more candidate MEC nodes 108-1 through 108-N as being configured to provide the service and/or being within a threshold distance from the user device 104.

The MEC node orchestrator 106 may obtain information to provide in the MEC node performance report by requesting, from the one or more candidate MEC nodes 108-1 through 108-N or from another device, information relating to performance indicators. The performance indicators may, for a particular candidate MEC node, relate to load (e.g., a current, recent, or predicted amount of traffic and/or quantity of devices communicating with the particular candidate MEC node, and/or the like), network resources (e.g., characteristics of bandwidth(s) that can be used to communicate with the particular candidate MEC node), network capabilities (a quantity of transceivers, characteristics of the transceivers, communication protocols available, and/or the like), computing resources (processing, memory, storage components, and/or the like), computing capabilities (operating systems, computer architecture, and/or the like), and/or the like.

As shown by reference number 120, the MEC node selection platform 102 may obtain the MEC node performance report from the MEC node orchestrator 106. In some implementations, the MEC node selection platform 102 may receive the MEC node performance report based on the MEC node selection platform 102 requesting the MEC node performance report. In some implementations, the MEC node selection platform 102 may receive the MEC node performance report based on a trigger, such as expiration of a period of time, detection of changed conditions (e.g., load, availability, capabilities, resources, and/or the like) at a quantity of the one or more candidate MEC nodes 108-1 through 108-N, an additional MEC node becoming available for MEC, and/or the like.

As shown by reference number 122, the MEC node selection platform 102 may select a MEC node for the service. The MEC node selection platform 102 may select the MEC node from the one or more candidate MEC nodes 108-1 through 108-N based on the MEC node performance report (e.g., the one or more performance indicators), the geographical location of the user device 104, the geographical locations of the one or more candidate MEC nodes 108-1 through 108-N, the performance requirement for the service, and/or the like.

In some implementations, the MEC node selection platform 102 may determine that a candidate MEC node that is geographically closest to the user device 104 fails to satisfy a threshold likelihood of satisfying the performance requirement for the service. For example, the candidate MEC node that is geographically closest to the user device 104 may not be configured to offer the service, may be overloaded, may not have sufficient computing or network capabilities available to perform the service, may not operate using a protocol or operating system that allows the candidate MEC node to satisfy a latency requirement for the service, and/or the like.

Based on the candidate MEC node that is geographically closest to the user device 104 failing to satisfy the performance requirement associated with the service, the MEC node selection platform 102 may select a MEC node that is not the geographically closest candidate MEC node. In some implementations, the MEC node selection platform 102 may select the MEC node that is not the geographically closest candidate MEC node based on the MEC node selection platform 102 determining that the MEC node satisfies the threshold likelihood of satisfying the performance requirement. The MEC node selection platform 102 may select the MEC node based on determining that the MEC node is a geographically closest, to the user device 104, MEC node that satisfies a threshold likelihood of satisfying the performance requirement. The MEC node selection platform 102 may determine that the MEC node satisfies a threshold likelihood of satisfying the performance requirement based on the one or more performance indicators, an indication in the MEC node performance report indicating a determination by the MEC node orchestrator 106, and/or the like.

In some implementations, permission to access at least one of the one or more candidate MEC nodes 108-1 through 108-N is based on a subscription status of a user associated with the user device 104. Based on the subscription status, the user device 104 may not have permission to access some of the one or more candidate MEC nodes 108-1 through 108-N. In some implementations, the MEC node selection platform 102 may select the MEC node based on determining that the user device 104 has permission to access the MEC node. For example, the MEC node selection platform 102 may filter out any of the one or more candidate MEC nodes 108-1 through 108-N to which the user device 104 does not have access.

In some implementations, the MEC node selection platform 102 may filter out any of the one or more candidate MEC nodes 108-1 through 108-N to which the user device 104 does not have access and any of the one or more candidate MEC nodes 108-1 through 108-N that fail to satisfy a threshold likelihood of satisfying the performance requirement. After filtering, the MEC node selection platform 102 may select the MEC node of the one or more candidate MEC nodes 108-1 through 108-N based on the geographical location of the MEC node and/or the geographical location of the user device 104 (e.g., select the MEC node based on the MEC node being a geographically closest MEC node to the user device 104,).

As shown in FIG. 1C, and by reference number 124, the MEC node selection platform 102 may provide information to be used by the user device 104 to communicate with the selected MEC node 110. For example, the information may comprise a network address of the MEC node, an authentication of the user device 104 as a permitted user of the MEC node (e.g., as determined by the MEC node selection platform 102 based on the subscription status), and/or the like.

As shown by reference number 126, the user device 104 may establish a connection with the selected MEC node 110. In some implementations, the established connection may include a direct wireless connection between the user device 104 and the selected MEC node 110. In some implementations, the established connection includes a connection via one or more intermediate devices, such as a network node, the MEC node selection platform 102, and/or the like.

As indicated above, FIGS. 1A-1C are provided merely as one or more examples. Other examples may differ from what is described with regard to FIGS. 1A-1C. For example, in practice, there may be networks between the devices, additional devices, fewer devices, different devices, or differently arranged devices than those shown in FIGS. 1A-1C.

FIG. 2 is a diagram of an example environment 200 in which systems and/or methods described herein may be implemented. As shown in FIG. 2, environment 200 may include one or more user devices 210 (referred to herein individually as user device 210 or collectively as user devices 210), a MEC node orchestrator 220, one or more MEC nodes 230 (referred to herein individually as MEC node 230 or collectively as MEC nodes 230), a MEC node selection platform 240, a computing resource 245, a cloud computing environment 250, and a network 260. Devices of environment 200 may interconnect via wired connections, wireless connections, or a combination of wired and wireless connections.

User device 210 includes one or more devices capable of receiving, generating, storing, processing, and/or providing information associated with a service. For example, user device(s) 210 may include a communication and/or computing device, such as a mobile phone (e.g., a smart phone, a radiotelephone, and/or the like), a laptop computer, a tablet computer, a handheld computer, a desktop computer, one or more servers, one or more server clusters, a gaming device, a wearable communication device (e.g., a smart wristwatch, a pair of smart eyeglasses, and/or the like), or a similar type of device.

MEC node orchestrator 220 includes one or more devices capable of receiving, storing, processing, and/or routing information associated with generating a MEC node performance report. In some implementations, MEC node orchestrator 220 may include a communication interface that allows MEC node orchestrator 220 to receive information from and/or transmit information to other devices in environment. For example, MEC node orchestrator 220 may use the communication interface to obtain indications of performance of the one or more MEC nodes 230 from the one or more MEC nodes 230 or another device.

MEC node 230 includes one or more devices capable of communicating with user device(s) 210. MEC node 230 may comprise hardware, firmware, or a combination of hardware and software and may be, for example, servers, security devices, devices implementing virtual machines, cloud computing resources, and/or the like. For example, MEC node 230 may include a communication and/or computing device, such as one or more servers (e.g., a DNS server), one or more server clusters, a mobile phone (e.g., a smart phone, a radiotelephone, and/or the like), a laptop computer, a tablet computer, a handheld computer, a desktop computer, a gaming device, a wearable communication device (e.g., a smart wristwatch, a pair of smart eyeglasses, and/or the like), a set-top box, a casting stick (e.g., a high-definition media interface (HDMI) dongle), a cable card, or a similar type of device. In some implementations, MEC node 230 may include a base transceiver station, a radio base station, a node B, an evolved node B (eNB), a gNB, a base station subsystem, a cellular site, a cellular tower (e.g., a cell phone tower, a mobile phone tower, and/or the like), an access point, a transmit receive point (TRP), a radio access node, a macrocell base station, a microcell base station, a picocell base station, a femtocell base station, or a similar type. MEC node 230 may provide one or more cells that cover geographic areas. Some MEC nodes 230 may be mobile base stations. Some MEC nodes 230 may be capable of communicating using multiple radio access technologies.

MEC node selection platform 240 includes one or more computing resources assigned to select a MEC node to provide a service to user device 210. For example, MEC node selection platform 240 may be a platform implemented by cloud computing environment 250 that may select a MEC node to provide a service to user device 210. In some implementations, MEC node selection platform 240 is implemented by computing resources 245 of cloud computing environment 250.

MEC node selection platform 240 may include a server device or a group of server devices. In some implementations, MEC node selection platform 240 may be hosted in cloud computing environment 250. Notably, while implementations described herein may describe MEC node selection platform 240 as being hosted in cloud computing environment 250, in some implementations, MEC node selection platform 240 may be non-cloud-based or may be partially cloud-based.

Cloud computing environment 250 includes an environment that delivers computing as a service, whereby shared resources, services, and/or the like may be provided to user device(s) 210. Cloud computing environment 250 may provide computation, software, data access, storage, and/or other services that do not require end-user knowledge of a physical location and configuration of a system and/or a device that delivers the services. As shown, cloud computing environment 250 may include MEC node selection platform 240 and computing resource 245.

Computing resource 245 includes one or more personal computers, workstation computers, server devices, or another type of computation and/or communication device. In some implementations, computing resource 245 may host MEC node selection platform 240. The cloud resources may include compute instances executing in computing resource 245, storage devices provided in computing resource 245, data transfer devices provided by computing resource 245, and/or the like. In some implementations, computing resource 245 may communicate with other computing resources 245 via wired connections, wireless connections, or a combination of wired and wireless connections.

As further shown in FIG. 2, computing resource 245 may include a group of cloud resources, such as one or more applications (“APPs”) 245-1, one or more virtual machines (“VMs”) 245-2, virtualized storage (“VSs”) 245-3, one or more hypervisors (“HYPs”) 245-4, or the like.

Application 245-1 includes one or more software applications that may be provided to or accessed by user device 210. Application 245-1 may eliminate a need to install and execute the software applications on user device 210. For example, application 245-1 may include software associated with MEC node selection platform 240 and/or any other software capable of being provided via cloud computing environment 250. In some implementations, one application 245-1 may send/receive information to/from one or more other applications 245-1, via virtual machine 245-2.

Virtual machine 245-2 includes a software implementation of a machine (e.g., a computer) that executes programs like a physical machine. Virtual machine 245-2 may be either a system virtual machine or a process virtual machine, depending upon use and degree of correspondence to any real machine by virtual machine 245-2. A system virtual machine may provide a complete system platform that supports execution of a complete operating system (“OS”). A process virtual machine may execute a single program and may support a single process. In some implementations, virtual machine 245-2 may execute on behalf of a user (e.g., user device 210), and may manage infrastructure of cloud computing environment 250, such as data management, synchronization, or long-duration data transfers.

Virtualized storage 245-3 includes one or more storage systems and/or one or more devices that use virtualization techniques within the storage systems or devices of computing resource 245. In some implementations, within the context of a storage system, types of virtualizations may include block virtualization and file virtualization. Block virtualization may refer to abstraction (or separation) of logical storage from physical storage so that the storage system may be accessed without regard to physical storage or heterogeneous structure. The separation may permit administrators of the storage system flexibility in how the administrators manage storage for end users. File virtualization may eliminate dependencies between data accessed at a file level and a location where files are physically stored. This may enable optimization of storage use, server consolidation, and/or performance of non-disruptive file migrations.

Hypervisor 245-4 provides hardware virtualization techniques that allow multiple operating systems (e.g., “guest operating systems”) to execute concurrently on a host computer, such as computing resource 245. Hypervisor 245-4 may present a virtual operating platform to the “guest operating systems” and may manage the execution of the guest operating systems. Multiple instances of a variety of operating systems may share virtualized hardware resources.

Network 260 includes one or more wired and/or wireless networks. For example, network 260 may include a cellular network (e.g., a long-term evolution (LTE) network, a code division multiple access (CDMA) network, a 3G network, a 4G network, a 5G network, another type of next generation network, and/or the like), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, a cloud computing network, and/or the like, and/or a combination of these or other types of networks.

The number and arrangement of devices and networks shown in FIG. 2 are provided as one or more examples. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of environment 200 may perform one or more functions described as being performed by another set of devices of environment 200.

FIG. 3 is a diagram of example components of a device 300. Device 300 may correspond to user device 210, MEC node orchestrator 220, MEC node 230, MEC node selection platform 240, and/or computing resource 245. In some implementations, user device 210, MEC node orchestrator 220, MEC node 230, MEC node selection platform 240, and/or computing resource 245 may include one or more devices 300 and/or one or more components of device 300. As shown in FIG. 3, device 300 may include a bus 310, a processor 320, a memory 330, a storage component 340, an input component 350, an output component 360, and a communication interface 370.

Bus 310 includes a component that permits communication among multiple components of device 300. Processor 320 is implemented in hardware, firmware, and/or a combination of hardware and software. Processor 320 is a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some implementations, processor 320 includes one or more processors capable of being programmed to perform a function. Memory 330 includes a random access memory (RAM), a read only memory (ROM), and/or another type of dynamic or static storage device (e.g., a flash memory, a magnetic memory, and/or an optical memory) that stores information and/or instructions for use by processor 320.

Storage component 340 stores information and/or software related to the operation and use of device 300. For example, storage component 340 may include a hard disk (e.g., a magnetic disk, an optical disk, and/or a magneto-optic disk), a solid state drive (SSD), a compact disc (CD), a digital versatile disc (DVD), a floppy disk, a cartridge, a magnetic tape, and/or another type of non-transitory computer-readable medium, along with a corresponding drive.

Input component 350 includes a component that permits device 300 to receive information, such as via user input (e.g., a touch screen display, a keyboard, a keypad, a mouse, a button, a switch, and/or a microphone). Additionally, or alternatively, input component 350 may include a component for determining location (e.g., a global positioning system (GPS) component) and/or a sensor (e.g., an accelerometer, a gyroscope, an actuator, another type of positional or environmental sensor, and/or the like). Output component 360 includes a component that provides output information from device 300 (via, e.g., a display, a speaker, a haptic feedback component, an audio or visual indicator, and/or the like).

Communication interface 370 includes a transceiver-like component (e.g., a transceiver, a separate receiver, a separate transmitter, and/or the like) that enables device 300 to communicate with other devices, such as via a wired connection, a wireless connection, or a combination of wired and wireless connections. Communication interface 370 may permit device 300 to receive information from another device and/or provide information to another device. For example, communication interface 370 may include an Ethernet interface, an optical interface, a coaxial interface, an infrared interface, a radio frequency (RF) interface, a universal serial bus (USB) interface, a wireless local area network interface, a cellular network interface, and/or the like.

Device 300 may perform one or more processes described herein. Device 300 may perform these processes based on processor 320 executing software instructions stored by a non-transitory computer-readable medium, such as memory 330 and/or storage component 340. As used herein, the term “computer-readable medium” refers to a non-transitory memory device. A memory device includes memory space within a single physical storage device or memory space spread across multiple physical storage devices.

Software instructions may be read into memory 330 and/or storage component 340 from another computer-readable medium or from another device via communication interface 370. When executed, software instructions stored in memory 330 and/or storage component 340 may cause processor 320 to perform one or more processes described herein. Additionally, or alternatively, hardware circuitry may be used in place of or in combination with software instructions to perform one or more processes described herein. Thus, implementations described herein are not limited to any specific combination of hardware circuitry and software.

The number and arrangement of components shown in FIG. 3 are provided as an example. In practice, device 300 may include additional components, fewer components, different components, or differently arranged components than those shown in FIG. 3. Additionally, or alternatively, a set of components (e.g., one or more components) of device 300 may perform one or more functions described as being performed by another set of components of device 300.

FIG. 4 is a flow chart of an example process 400 for systems and methods for MEC node selection. In some implementations, one or more process blocks of FIG. 4 may be performed by a MEC node selection platform (e.g., MEC node selection platform 102 and/or 240). In some implementations, one or more process blocks of FIG. 4 may be performed by another device or a group of devices separate from or including the MEC node selection platform, such as a user device (e.g., user device 104 and/or 210), a MEC node orchestrator (e.g., MEC node orchestrator 106 and/or 220), a MEC node (e.g., one or more of candidate MEC nodes 108-1 through 108-N, selected MEC node 110, MEC node 230 and/or the like), a computing resource (e.g., computing resource 245), and/or the like.

In some implementations, the MEC node selection platform is configured to perform a domain name system service lookup. A domain name may be associated with at least one device (e.g., one or more of candidate MEC nodes 108-1 through 108-N, one or more MEC nodes 230, and/or the like).

As shown in FIG. 4, process 400 may include receiving, from a user device, a request to access a service via MEC (block 410). For example, the MEC node selection platform (e.g., using computing resource 245, processor 320, memory 330, storage component 340, input component 350, output component 360, communication interface 370 and/or the like) may receive, from a user device, a request to access a service via MEC, as described above.

In some implementations, the request may identify a domain name associated with the service and may indicate that the request is to access the service via MEC. In some implementations, the MEC node selection platform receives the request via an application programming interface. The request may include one or more fields of information including indications of one or more of the service, a performance requirement for the service, a service type of the service, the geographical location of the user device, or a subscription status of a user of the user device.

In some implementations, the service may be associated with a performance requirement (e.g., a latency requirement, an acceptable error rate, and/or the like).

As further shown in FIG. 4, process 400 may include determining a geographical location of the user device (block 420). For example, the MEC node selection platform (e.g., using computing resource 245, processor 320, memory 330, storage component 340, input component 350, output component 360, communication interface 370 and/or the like) may determine a geographical location of the user device, as described above.

As further shown in FIG. 4, process 400 may include requesting (e.g., from a MEC node orchestrator), a MEC node performance report, wherein the MEC node performance report identifies one or more candidate MEC nodes that are configured to provide access to the service, wherein the MEC node performance report indicates one or more performance indicators for the one or more candidate MEC nodes, and wherein the one or more performance indicators relate to one or more of load, network capabilities, or computing capabilities (block 430). For example, the MEC node selection platform (e.g., using computing resource 245, processor 320, memory 330, storage component 340, input component 350, output component 360, communication interface 370 and/or the like) may request, from a MEC node orchestrator, a MEC node performance report, as described above.

In some implementations, the MEC node performance report may identify one or more candidate MEC nodes that are configured to provide access to the service. In some implementations, the MEC node performance report may indicate one or more performance indicators for the one or more candidate MEC nodes. In some implementations, the one or more performance indicators relate to one or more of load, network resources, network capabilities, computing resources, computing capabilities, and/or the like.

As further shown in FIG. 4, process 400 may include receiving, from the MEC node orchestrator, the MEC node performance report (block 440). For example, the MEC node selection platform (e.g., using computing resource 245, processor 320, memory 330, storage component 340, input component 350, output component 360, communication interface 370 and/or the like) may receive, from the MEC node orchestrator, the MEC node performance report, as described above.

As further shown in FIG. 4, process 400 may include selecting, based on the one or more performance indicators and the geographical location of the user device, a MEC node from the one or more candidate MEC nodes (block 450). For example, the MEC node selection platform (e.g., using computing resource 245, processor 320, memory 330, storage component 340, input component 350, output component 360, communication interface 370 and/or the like) may select, based on the one or more performance indicators and the geographical location of the user device, a MEC node from the one or more candidate MEC nodes, as described above.

In some implementations, process 400 may include determining, by the MEC node selection platform, that a geographically closest, to the user device, MEC node of the one or more candidate MEC nodes fails to satisfy a threshold likelihood of satisfying a performance requirement associated with the service. Process 400 may further include selecting the MEC node instead of the geographically closest, to the user device, MEC node based on the geographically closest, to the user device, MEC node failing to satisfy the performance requirement associated with the service.

In some implementations, process 400 may further include determining that the MEC node satisfies a threshold likelihood of satisfying the performance requirement based on the one or more performance indicators, and selecting the MEC node based on the MEC node satisfying the threshold likelihood of satisfying the performance requirement.

Process 400 may further comprise determining that the MEC node is a geographically closest, to the user device, MEC node of the one or more candidate MEC nodes that satisfies a threshold likelihood of satisfying the performance requirement, and selecting the MEC node based on the MEC node being the geographically closest, to the user device, MEC node of the one or more candidate MEC nodes that satisfies the threshold likelihood of satisfying the performance requirement.

In some implementations, permission to access at least one of the one or more candidate MEC nodes is based on a subscription status of a user associated with the user device. Process 400 may include determining that the user associated with the user device has permission to access the MEC node based on the subscription status of the user, and selecting the MEC node based on determining that the user device has permission to access to the MEC node.

In some implementations, process 400 may include determining that at least one of the one or more candidate MEC nodes satisfies a threshold likelihood of satisfying the performance requirement based on the one or more performance indicators, and selecting the MEC node from the at least one of the one or more candidate MEC nodes based on the geographical location of the user device and geographical locations of the one or more candidate MEC nodes (e.g., the one or more candidate MEC nodes for which the user device has permission to access).

In some implementations, process 400 may include selecting the MEC node from the one or more candidate MEC nodes by selecting the MEC node from at least one of the one or more candidate MEC nodes that are associated with a domain name included in the request for service via MEC.

As further shown in FIG. 4, process 400 may include providing, to the user device, information to be used by the user device to communicate with the MEC node (block 460). For example, the MEC node selection platform (e.g., using computing resource 245, processor 320, memory 330, storage component 340, input component 350, output component 360, communication interface 370 and/or the like) may provide, to the user device, information to be used by the user device to communicate with the MEC node, as described above. In some implementations, the information to be used by the user device to communicate with the MEC node may include a network address of the MEC node.

Process 400 may include additional implementations, such as any single implementation or any combination of implementations described above and/or in connection with one or more other processes described elsewhere herein.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

The foregoing disclosure provides illustration and description, but is not intended to be exhaustive or to limit the implementations to the precise forms disclosed. Modifications and variations may be made in light of the above disclosure or may be acquired from practice of the implementations.

As used herein, the term “component” is intended to be broadly construed as hardware, firmware, or a combination of hardware and software.

As used herein, satisfying a threshold may, depending on the context, refer to a value being greater than the threshold, more than the threshold, higher than the threshold, greater than or equal to the threshold, less than the threshold, fewer than the threshold, lower than the threshold, less than or equal to the threshold, equal to the threshold, and/or the like, depending on the context.

It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, a combination of related and unrelated items, and/or the like), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method, comprising:
receiving, by a multi-access edge computing (MEC) node selection platform and from a user device, a request to access a service via MEC,
determining, by the MEC node selection platform, a geographical location of the user device;
requesting, by the MEC node selection platform and from a MEC node orchestrator, a MEC node performance report,
wherein the MEC node performance report indicates one or more performance indicators for one or more candidate MEC nodes that are configured to provide access to the service; and
receiving, by the MEC node selection platform and from the MEC node orchestrator, the MEC node performance report;
selecting, by the MEC node selection platform and based on the one or more performance indicators and the geographical location of the user device, a MEC node from the one or more candidate MEC nodes; and
providing, by the MEC node selection platform and to the user device, information to be used by the user device to communicate with the MEC node.

2. The method of claim 1, wherein the one or more performance indicators relate to one or more of load, network resources, network capabilities, computing resources, or computing capabilities.

3. The method of claim 1, wherein the MEC node selection platform is configured to perform a domain name system service lookup.

4. The method of claim 1, wherein the information to be used by the user device to communicate with the MEC node comprises a network address of the MEC node.

5. The method of claim 1, wherein the MEC node selection platform receives the request via an application programming interface, and
wherein the request includes one or more fields of information including indications of one or more of the service, a performance requirement for the service, a service type of the service, the geographical location of the user device, or a subscription status of a user of the user device.

6. The method of claim 1, further comprising:
determining, by the MEC node selection platform, that a geographically closest, to the user device, MEC node of the one or more candidate MEC nodes fails to satisfy a threshold likelihood of satisfying a performance requirement associated with the service; and
selecting the MEC node instead of the geographically closest, to the user device, MEC node based on the geographically closest, to the user device, MEC node failing to satisfy the performance requirement associated with the service.

7. The method of claim 1, wherein the service is associated with a performance requirement,
wherein the method further comprises determining that the MEC node satisfies a threshold likelihood of satisfying the performance requirement based on the one or more performance indicators, and
wherein the MEC node selection platform selects the MEC node based on the MEC node satisfying the threshold likelihood of satisfying the performance requirement.

8. The method of claim 1, wherein the service is associated with a performance requirement,
wherein the method further comprises determining that the MEC node is a geographically closest, to the user device, MEC node of the one or more candidate MEC nodes that satisfies a threshold likelihood of satisfying the performance requirement, and
wherein the MEC node selection platform selects the MEC node based on the MEC node being the geographically closest, to the user device, MEC node of the one or more candidate MEC nodes that satisfies the threshold likelihood of satisfying the performance requirement.

9. The method of claim 1, wherein permission to access at least one of the one or more candidate MEC nodes is based on a subscription status of a user associated with the user device,
wherein the method further comprises determining that the user associated with the user device has permission to access the MEC node based on the subscription status of the user, and
wherein the MEC node selection platform selects the MEC node based on determining that the user device has permission to access to the MEC node.

10. A multi-access edge computing (MEC) selection platform, comprising:
one or more memories; and
one or more processors, communicatively coupled to the one or more memories, configured to:
receive, from a user device, a request to access a service via MEC,
wherein the request identifies a domain name that is associated with the service and indicates that the request is to access the service via MEC;
determine a geographical location of the user device;
obtain, based on the request, a MEC node performance report,
wherein the MEC node performance report indicates one or more performance indicators for one or more candidate MEC nodes that are configured to provide access to the service;
select, based on the one or more performance indicators and the geographical location of the user device, a MEC node from the one or more candidate MEC nodes; and
provide, to the user device, a network address of the MEC node to permit the user device to communicate with the MEC node.

11. The MEC selection platform of claim 10, wherein the one or more performance indicators relate to one or more of load, network resources, network capabilities, computing resources, or computing capabilities.

12. The MEC selection platform of claim 10, wherein the MEC selection platform is configured to perform a domain name system service lookup,
wherein the domain name is associated with at least one of the one or more candidate MEC nodes, and
wherein the one or more processors are further configured to select the MEC node from the one or more candidate MEC nodes by selecting the MEC node from the at least one of the one or more candidate MEC nodes.

13. The MEC selection platform of claim 10, wherein the one or more processors are further configured to:
determine that a geographically closest, to the user device, MEC node of the one or more candidate MEC nodes fails to satisfy a threshold likelihood of satisfying a performance requirement associated with the service; and
select the MEC node instead of the geographically closest, to the user device, MEC node based on the geographically closest, to the user device, MEC node failing to satisfy the performance requirement associated with the service.

14. The MEC selection platform of claim 10, wherein the service is associated with a performance requirement, and
wherein the one or more processors are further configured to:
determine that the MEC node satisfies a threshold likelihood of satisfying the performance requirement based on the one or more performance indicators; and
select the MEC node based on the MEC node satisfying the threshold likelihood of satisfying the performance requirement.

15. The MEC selection platform of claim 10, wherein permission to access at least one of the one or more candidate MEC nodes is based on a subscription status of a user associated with the user device;
wherein the one or more processors are further configured to:
determine that the user associated with the user device has permission to access the MEC node based on the subscription status of the user; and
select the MEC node based on a determination that the user device has permission to access to the MEC node.

16. A non-transitory computer-readable medium storing instructions, the instructions comprising:
one or more instructions that, when executed by one or more processors, cause the one or more processors to:
receive, from a user device and via an application programming interface, a request to access a service, via multi-access edge computing (MEC), that is associated with a performance requirement,
wherein the request includes one or more fields that indicate one or more of the service, the performance requirement for the service, a service type of the service, a geographical location of the user device, or a subscription status of a user of the user device;
determine the geographical location of the user device based on the request;
obtain, based on the request, a MEC node performance report,
wherein the MEC node performance report indicates one or more performance indicators for one or more candidate MEC nodes that are configured to provide access to the service, and
wherein the one or more performance indicators relate to one or more of load, network resources, network capabilities, computing resources, or computing capabilities;
select a MEC node from the one or more candidate MEC nodes based on the one or more performance indicators, the performance requirement, and the geographical location of the user device; and
provide, to the user device, information to be used by the user device to communicate with the MEC node.

17. The non-transitory computer-readable medium of claim 16, wherein the one or more instructions, when executed by the one or more processors, further cause the one or more processors to:
determine that a geographically closest, to the user device, MEC node of the one or more candidate MEC nodes fails to satisfy a threshold likelihood of satisfying the performance requirement based on the one or more performance indicators; and
select the MEC node instead of the geographically closest, to the user device, MEC node based on the geographically closest, to the user device, MEC node failing to satisfy the performance requirement associated with the service.

18. The non-transitory computer-readable medium of claim 16, wherein the one or more instructions, when executed by the one or more processors, further cause the one or more processors to:
determine that at least one of the one or more candidate MEC nodes satisfies a threshold likelihood of satisfying the performance requirement based on the one or more performance indicators; and
select the MEC node from the at least one of the one or more candidate MEC nodes based on the geographical location of the user device and geographical locations of the at least one of the one or more candidate MEC nodes.

19. The non-transitory computer-readable medium of claim 18, wherein the one or more instructions, when executed by the one or more processors, further cause the one or more processors to select the MEC node based on a determination that the MEC node is a geographically closest, to the user device, MEC node of the at least one of the one or more candidate MEC nodes.

20. The non-transitory computer-readable medium of claim 16, wherein permission to access at least one of the one or more candidate MEC nodes is based on the subscription status of the user of the user device;
wherein the one or more instructions, when executed by the one or more processors, further cause the one or more processors to:
determine that the user of the user device has permission to access the MEC node based on the subscription status of the user; and
select the MEC node based on a determination that the user has permission to access to the MEC node.
